(19) United States
(12) Patent Application Publication
(10) Pub. No.: US 2006/0050114 A1
(43) Pub. Date: Mar. 9, 2006

(54) Ink cartridge for ink-jet recording apparatus and method for manufacturing the same

(75) Inventors: Noriatsu Aoi, Ichinomiya-shi (JP); Noriaki Satoh, Nagoya-shi (JP); Masaya Fujioka, Nagoya-shi (JP); Shunichi Higashiyama, Yotsukaichi-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/218,435

(22) Filed: Sep. 6, 2005

(30) Foreign Application Priority Data
Sep. 6, 2004 (JP) 2004-258936

(51) Int. Cl. B41J 2/175

(52) U.S. Cl. 347/86

(57) ABSTRACT

An ink cartridge for ink-jet recording apparatus includes an ink tank usable in an ink-jet recording apparatus and a water base ink filled in the ink tank. In the ink cartridge, the ink tank is formed of polyolefin containing a sorbitol derivative as a crystal-nucleating agent, and the pH of the water base ink filled in the tank has been adjusted to be not less than 4.0 to less than 8.0. This makes it is possible to prevent the sorbitol derivative, contained in the polyolefin as the crystal-nucleating agent, from depositing in the water base ink filled in the ink tank.

### BACKGROUND OF THE INVENTION

1. Field of the Invention:

The present invention relates to an ink cartridge for ink-jet recording apparatus including an ink tank usable in an ink-jet recording apparatus and a water base ink filled in the ink tank, a method for manufacturing the ink cartridge, and an ink-jet recording apparatus provided with the ink cartridge for ink-jet recording apparatus.

2. Description of the Related Art:

In the ink-jet recording method, minute ink droplets are discharged from minute nozzles toward a recording objective by using a discharge system such as the thermal system and the piezo system. In the ink-jet recording apparatuses provided with such an ink discharge system, a construction in which an ink cartridge having an ink tank filled with a water base ink is directly and detachably attached to an ink-jet head is widely practiced so as to improve the user-friendliness. In addition, for the purpose of downsizing ink-jet recording apparatus (miniaturization of ink-jet head, miniaturization of driving motor for ink-jet head and the like), a construction has been devised in which an ink cartridge is not directly attached to an ink-jet head but instead is arranged below a platen, and the ink cartridge and the ink-jet head are connected via a flexible tube for supplying ink (U.S. patent application Publication No. US 2003/0107625 A1 corresponding to Japanese Patent Application Laid-open No. JP 2003-175631).

In the ink-jet recording apparatus provided with such an ink cartridge, it is necessary to prevent foreign matters, which inhibits the flow of the ink, from contaminating into the ink channel in the ink-jet recording apparatus in order to maintain the smooth and highly accurate discharge of the water base ink from minute nozzles. For this purpose, countermeasures are taken such as assembling parts for the ink channel of ink-jet recording apparatus in a clean room and performing microfiltration of the ink during the preparation of the ink. However, these countermeasures are not sufficient. In order to avoid the contamination with foreign matters more reliably, it is also necessary to suppress the contamination with foreign matters originated from the material of ink tank of the ink cartridge. Accordingly, an ink tank of a conventional ink cartridge for ink-jet recording apparatus is formed of polyolefin, such as polyethylene and polyproplyene, since the polyolefin is a material having the properties that polyolefin does not alter the water base ink and is not affected by the water base ink, and since the polyolefin has a satisfactory recyclability in view of the preservation of the earth environment and having a satisfactory processability in view of reducing the processing cost.

In the recent years, there is a demand that a remaining amount of ink in the ink tank of ink cartridge should be visually observable from outside in view of the user-friendliness. However, there are problems such that the ink tank formed of polyolefin scatters the light and most of the ink tank does not have sufficient transparency because in general the crystalline structure of the formed tank is not uniform. In view of these problems, it has been devised to add bis(p-methylbenzylidene)sorbitol to the polyolefin as a crystal-nucleating agent in order to realize a minute and uniform crystalline structure in the polyolefin, thereby increasing the transparency. However, bis(p-methylbenzylidene)sorbitol is easily eluted into the ink and deposited in the ink. For this reason, it has been devised to add bis(dimethylbenzylidene)sorbitol or bis(p-ethylbenzylidene)sorbitol to the polyolefin as the crystal-nucleating agent, in place of bis(p-methylbenzylidene) sorbitol (U.S. Pat. No. 6,270,209 B1 corresponding to Japanese Patent Application Laid-open No. 2000-263813).

There is, however, the following problem associated with the addition of the sorbitol derivatives disclosed in U.S. Pat. No. 6,270,209 B1 as the crystal-nucleating agent to the polyolefin forming the ink tank. Depending on the kind of ink, bis(dimethylbenzylidene) sorbitol or bis(p-ethylbenzylidene)sorbitol is eluted into the water base ink from the inner wall of ink-tank having been contact with the ink for a long period of time and is deposited in the water base ink, thereby causing the clog-up of minute nozzles or the like.

### SUMMARY OF THE INVENTION

The present invention has been made in order to solve the problems as described above, an object of which is to provide a novel ink cartridge which is formed of polyolefin containing a sorbitol derivative as the crystal-nucleating agent and capable of preventing the deposition of the sorbitol derivative as the crystal-nucleating agent in the water base ink in the ink tank of the ink cartridge.

The inventors discovered that the deposition of the sorbitol derivative, which is the crystal-nucleating agent included in the polyolefin forming the ink tank of the ink cartridge for ink-jet recording apparatus, in the water base ink is closely related with the pH value of the water base ink, and the inventors found out that the above-described objective can be achieved by controlling the pH value of the water base ink within a predetermined range. Thus, the inventors completed the present invention.

According to a first aspect of the present invention, there is provided an ink cartridge for ink-jet recording apparatus, comprising: an ink tank formed of polyolefin including a crystal-nucleating agent; and a water base ink filled in the ink tank and having a pH of not less than 4.0 to less than 8.0. In the present invention, there is also provided an ink-jet recording apparatus comprising this ink cartridge for ink-jet recording apparatus.

In the ink cartridge for ink-jet recording apparatus of the present invention, although the ink tank is formed of the polyolefin including the crystal-nucleating agent such as, for example, a sorbitol derivative, the pH value of the water base ink filled in the ink tank has been adjusted to be not less than 4.0 to less than 8.0. Accordingly, it is possible to prevent the elution of the sorbitol derivative from the inner wall of ink tank which is to be in contact with the water-base ink for a long period of time and to prevent the deposition of the sorbitol derivate in the ink. Therefore, in an ink-jet recording apparatus including such an ink cartridge, it is possible to prevent the clog-up of the nozzles which would be otherwise caused by the sorbitol derivative. In the present invention regarding the ink cartridge, the term “pH of water base ink” means the pH of water base ink which is filled in the ink tank of the ink cartridge product.

According to a second aspect of the present invention, there is provided a method of manufacturing an ink cartridge for ink-jet recording apparatus, the method comprising: providing an ink tank formed of polyolefin including a crystal-nucleating agent; and charging a water base ink having a pH of not less than 4.0 to less than 8.0 in the ink tank. With the method for manufacturing the ink cartridge of the present invention, the ink cartridge of the present invention is manufactured. In the present invention regarding the method for manufacturing the ink cartridge, the term “pH of water base ink” means the pH of water base ink before the water base ink, as one component of the ink cartridge product, is filled in the ink tank which is the other component of the ink cartridge product. The pH of water base ink tends to lower over time, due to the oxidation of a solvent or the like, after the ink cartridge has been manufactured by filling the water base ink in the ink tank. However, this change of the pH over time is not substantial, as appreciated from the results of Examples which will be described later on.

### BRIEF DESCRIPTION OF DRAWINGS

FIG. 1 is a perspective view showing a color ink-jet printer having an ink cartridge prepared in examples of the present invention;

FIG. 2 is a perspective view of a head unit, with its nozzles facing upward; and

FIG. 3 is a schematic diagram showing the ink jet print head and a controller.

### DESCRIPTION OF THE PREFERRED EMBODIMENTS

The present invention will be explained in detail as below. The ink cartridge for ink-jet recording apparatus of the present invention includes an ink tank and a water base ink filled in the ink tank. In the present invention, the ink tank is formed of polyolefin having the properties of not altering the water base ink and of not being affected by the water base ink. In addition, polyolefin contains a sorbitol derivative as the crystal-nucleating agent. Accordingly, the transparency of the polyolefin is enhanced, thereby making it easy to visually observe the water base ink in the ink tank from outside of the ink tank.

In this case, there is a concern that the sorbitol derivative as the crystal-nucleating agent would deposit in the water base ink filled in the ink tank. In the present invention, however, the problem of elution has been solved by adjusting the pH value of the water base ink to be not less than 4.0 to less than 8.0. Namely, when the water base ink is filled in the ink tank, which is formed of polyolefin containing the sorbitol derivative as the crystal-nucleating agent, and the pH value of the water base ink is not less than 8.0, it is not desired because the sorbitol derivative is deposited in the ink to the extent which is not acceptable, resulting in the clog-up of the minute nozzles in the ink-jet head, and consequently the highly accurate discharge of the ink is prevented. On the other hand, when the pH value of the water base ink is less than 4.0, it is not desired because the ink corrodes metal used in the ink flow passage of ink-jet recording apparatus, or the solubility of an acidic dye or direct dye is lowered, resulting in lowering the accuracy of discharge. For the above reasons, as the water base ink in the present invention, a water base ink is used in which the pH value is not less than 4.0 to less than 8.0, preferably not less than 5.0 to less than 7.5, especially preferably not less than 6.0 to less than 7.5. As a result, it is possible to prevent the deposition of the crystal-nucleating agent in the water base ink from the inner wall of the ink tank.

The method for adjusting the pH value of the water base ink to be not less than 4.0 to less than 8.0 includes, for example, the method in which a pH-adjusting agent such as acid or alkaline is blended to the water base ink. As the pH-adjusting agent, either of inorganic compound and organic compound may be used. As the inorganic compound, inorganic acid and inorganic alkali may be used, and as the organic compound, organic acid and organic alkali may be used.

The inorganic acid may be exemplified by hydrochloric acid, sulfuric acid, nitric acid, boric acid, silicic acid and the like. The inorganic alkali may be exemplified by sodium hydrate, potassium hydrate, lithium hydroxide, ammonium hydroxide and the like. Salt of ammonium sulfate and salt of sodium carbonate and the like may also be used.

The organic acid may be exemplified by a compound having a carboxylic acid group or sulfonic acid group such as formic acid, acetic acid, benzoic acid, benzenesulfonic acid. The organic alkali may be exemplified by an amine compound such as monoethanolamine. Salt of sodium acetate and salt of triethanolamine and the like may also be used. It is also possible to use Good's buffer used mainly in the biochemical field and exemplified by a derivative of aminoethanesulfonic acid and the like.

The inorganic compounds or the organic compounds as the pH-adjusting agents explained above may be used singly, or in a mixture of any combination thereof. While the pH-adjusting agent in the water base ink is added in appropriate amount in accordance with the desired pH, the content of the pH-adjusting agent is usually 0.01 to 1% by weight, preferably 0.05 to 0.5% by weight with respect to the total amount of the water base ink.

The shape and size of the ink cartridge for ink-jet recording apparatus and the ink tank of the present invention are determined in accordance with the structure of an ink-jet recording apparatus to which the ink cartridge and ink tank are applied. For example, when the ink cartridge for ink-jet recording apparatus is directly attached to an ink jet head, as arranged in a generally-used ink-jet recording apparatus, the shape and size of the ink cartridge and ink tank may be determined in accordance with the shape of the ink-jet head and the volume and shape of inner space of the recording apparatus and the like. Alternatively, as disclosed in U.S. patent application Publication No. US 2003/0107625 A1, when an ink cartridge for ink-jet recording apparatus is not directly attached to the ink-jet head but instead the ink-jet head and the ink cartridge are separately arranged from each other in the ink-jet recording apparatus while being connected to each other via a flexible tube for supplying ink, the shape and size of the ink cartridge and ink tank may be determined in accordance with the shape of ink-jet head, the arrangement of flexible tube, and the volume and shape of the inner space of the recording apparatus and the like.

In the present invention, the polyolefin forming the ink tank may be selected and used in accordance with required characteristics such as impact strength, chemical resistance, rigidity and the like. The polyolefin may include a homopolymer of ethylene (polyethylene), a homopolymer of propylene (polypropylene), a random copolymer including a propylene skeleton or a block copolymer including a propylene skeleton and the like. In this case, monomer to be copolymerized with propylene may include ethylene, buthylene, butadiene, stylene and the like. As the polyolefine, in view of the moldability, rigidity and cost, it is preferable to use the homopolymer of ethylene (polyethylene) and the homopolymer of propylene (polypropylene). In particular, in view of moldability and physical property, a polypropylene having an isotactic structure is preferred. In particular, when the transparency is required, a propylene-ethylene random copolymer may be preferably used.

In the present invention, for the purpose of enhancing the transparency, a sorbitol derivative is used as the crystal-nucleating agent to be contained in polyolefin. The sorbitol derivative may be exemplified by dibenzylidene sorbitol, bis(p-methylbenzylidene)sorbitol, bis(p-ethylbenzylidene)sorbitol, bis(dimethylbenzylidene)sorbitol, bis(p-chlorobenzylidene)sorbitol, benzylidene-p-chlorobenzylidene sorbitol, benzylidene sorbitol in which benzylidene is substituted with an alkyl group having a number of carbon or carbons of 1 to 8, and the like. These sorbitol derivatives may be used singly, or in a mixture of any combination thereof.

The content of the sorbitol derivative as the crystal-nucleating agent in the polyolefin is preferably 0.01 to 1 part by weight, and more preferably 0.05 to 0.5 part by weight with respect to 100 parts by weight of the polyolefin for the following reason. If the content is small like less than 0.01 part by weight, the effect to enhance the transparency is insufficient. If the content is great like more than 1 part by weight, remarkable effect appropriate for the blended amount is hardly obtained.

In addition to the crystal-nucleating agent, an antioxidant such as a primary antioxidant or a secondary antioxidant may be added to the polyolefin so as to prevent the deterioration of quality due to the corrosion by the oxidation of polyolefin, thereby stabilizing the quality.

The primary antioxidant prevents a chain reaction of oxidation/degradation due to radicals occurred in the polymer, and may be exemplified by a phenol-based antioxidant and an amine-based antioxidant. The phenol-based antioxidant may be specifically exemplified by octadecyl-3-(3,5-di-tert-butyl-4-hydroxyphenyl)propionate, 3,9-bis[2-{3-(3-tert-butyl-4-hydroxy-5-methylphenyl)propyonyloxy}-1,1-dimethylethyl]-2,4,8,10-tetraoxaspiro[5 • 5]undecane, triethylene glycol-N-bis-3-(3-tert-butyl-5-methyl-4-hydroxyphenyl)propionate, 1,6-hexanediolbis[3-(3,5-di-tert-butyl-4-hydroxyphenyl)propionate], 2,2-thiobis-diethylenebis[3-(3,5-di-tert-butyl-4-hydroxyphenyl)propionate] and the like. The amine-based antioxidant may be specifically exemplified by dimethyl succinate/1-(2-hydroxyethyl)-4-hydroxy-2,2,6,6-tetramethyl piperidine polycondensate, bis(2,2,6,6-tetramethyl-4-piperidyl)sebacate and the like.

The secondary antioxidant decomposes peroxides occurred in the polymer while preventing the occurrence of radicals, and may be exemplified by a sulfur-based antioxidant and a phosphorus-based antioxidant. The sulfur-based antioxidant may be specifically exemplified by dilauryl 3,3-thiodipropionate, tridecyl 3,3′-thiodipropionate, dimyristyl 3,3′-thiodipropionate, distearyl 3,3′-thiodipropionate, laurylstearyl 3,3′-thiodipropionate, neo-pentane tetrayl tetrakis(3-laurylthiopropionate), bis[2-methyl-4-(3-n-alkyl(having a number of carbons of 12 to 14)thiopropionyloxy)-5-tert-butylphenyl]sulfide and the like. The phosphorus-based antioxidant may be specifically exemplified by triphenyl phosphite, tris(nonylphenyl)phosphite, tris(2,4-di-tert-butylphenyl)phosphite, trilauryl phosphite, trioctadecyl phosphite, distearyl pentaerythritol diphosphite, diisodecyl pentaerythritol diphosphite, bis(2,4-di-tert-butylphenyl)pentaerythritol diphosphite, bis(2,4-di-tert-butyl-6-methylphenyl)pentaerythritol diphosphite, bis(2,6-di-tert-butyl-4-methylphenyl)pentaerythritol diphosphite, bis(2,4,6-tri-tert-butylphenyl)pentaerythritol diphosphite, tristearyl sorbitol triphosphite and the like.

The polypropylene having an isotactic structure, which is used as the polyolefin forming the ink tank, is manufactured by means of the coordination anion polymerization method in which a chlorine-based catalyst such as titanium tetrachloride. Accordingly, there is a possibility that the chlorine-based catalyst may mix into the polyolefin. There is a concern, however, that the chlorine-based catalyst may corrode a metal mold used during the molding of ink tank. Accordingly, in the present invention, it is desired to add a neutralizing agent to the polyolefin for the purpose of neutralizing the chlorine-based catalyst. As such a neutralizing agent, it is possible to choose an appropriate neutralizing agent among known neutralizing agents, which hardly generates insoluble matter produced through the reaction of the ink components and the neutralizing agent. The neutralizing agent may be specifically exemplified by a fatty acid derivative such as calcium stearate. When the fatty acid derivative is used as the neutralizing agent, it is desired that the content of the fatty acid derivative in the polyolefin is restricted as small as possible, provided that the content is sufficient for neutralizing the chlorine-based catalyst. The content is preferably not more than 1 part by weight, and more preferably not more than 0.3 part by weight with respect to 100 parts by weight of the polyolefin.

In the present invention, the polyolefin may be added with various kinds of additives such as stabilization agent, ultraviolet absorbing agent, antistatic agent and the like, as necessary.

The water base ink filled in the ink tank of the ink cartridge of the present invention includes at least water, a water-soluble organic solvent and a coloring agent which disperses or dissolves in the water, on the premises that the pH value of the ink is not less than 4.0 to less than 8.0.

As the water to be contained in the water base ink, it is preferable to use deionized water (pure water). The content of the water is 10 to 98% by weight, preferably 30 to 97% by weight, more preferably 40 to 95% by weight with respect to the total weight of the water base ink, so that the viscosity of the ink under the ordinary condition is maintained to be low with which a normal discharge of the ink can be performed.

The water-soluble organic solvent contained in the water base ink is principally used in order to avoid the drying-up of the ink at the tip of the ink-jet head. Accordingly, it is preferable to select a water-soluble organic solvent which has low volatility and high dye-dissolving ability. Such a water-soluble organic solvent may be specifically exemplified by polyalkylene glycols such as polyethylene glycol; alkylene glycols such as ethylene glycol, propylene glycol, butylene glycol, diethylene glycol, dipropylene glycol, triethylene glycol, tripropylene glycol, 1,2,6-hexanetriol, thiodiglycol, 1,3-butanediol, 1,5-pentanediol, and hexylene glycol; glycerol; and pyrrolidones such as 2-pyrrolidone and N-methyl-2-pyrrolidone. These water-soluble organic solvents may be used singly, or in a mixture of any combination thereof.

The content of the water-soluble organic solvent in the water base ink is preferably 5 to 40% by weight, more preferably 7 to 40% by weight, especially preferably 10 to 30% by weight. If the content is small like less than 5% by weight, the moistening action is insufficient, problems such as deposition and drying-up are likely to occur in some cases. If the content is great like more than 40% by weight, the viscosity of the water base ink may be unnecessarily increased, the ink may not be jetted, and the ink may be dried extremely slowly on the recording paper.

As the coloring agent which is used in the water base ink and which disperses or dissolves in the water, a dye or a pigment may be used.

As the dye, cationic dyes such as basic dye, acid dye, direct dye and reactive dye or anionic dyes may be preferably used. The basic dye may be exemplified by Color Index (hereinafter referred to as C. I.) Basic Blue 3, 6, 7, 9, 11, 12, 16, 17, 24, 26, 41, 47, 66; C. I. Basic Red 1, 1:1, 2, 12, 13, 14, 18, 22, 27, 28, 29, 34, 38, 39, 46, 46:1, 67, 69, 70; C. I. Basic Yellow 1, 2, 11, 19, 21, 24, 25, 28, 29, 36, 45, 51, 67, 73; C. I. Basic Orange 14, 21, 22, 32; C. I. Basic Violet 1, 2, 3, 4, 5, 7, 8, 10, 11, 11:1, 20, 33; C. I. Basic Brown 1, 4; C. I. Basic Green 1, 4, 5, and the like. The acid dye may be exemplified by C. I. Acid Black 2, 7, 24, 26, 31, 52, 63, 112, 118; C. I. Acid Blue 9, 22, 40, 59, 93, 102, 104, 113, 117, 120, 167, 229, 234; C. I. Acid Red 1, 6, 32, 37, 51, 52, 80, 85, 87, 92, 94, 115, 181, 256, 289, 315, 317; C. I. Acid Yellow 11, 17, 23, 25, 29, 42, 61, 71; C. I. Acid Orange 7, 19; C. I. Acid Violet 49, and the like. The direct dye may be exemplified by C. I. Direct Black 17, 19, 32, 51, 71, 108, 146, 154, 168; C. I. Direct Blue 6, 22, 25, 71, 86, 90, 106, 199; C. I. Direct Red 1, 4, 17, 28, 83, 227; C. I. Direct Yellow 12, 24, 26, 86, 98, 132, 142; C. I. Direct Orange 34, 39, 44, 46, 60; C. I. Direct Violet 47, 48; C. I. Direct Brown 109; C. I. Direct Green 59, and the like. The reactive dye may be exemplified by C. I. Reactive Blue 2, 5, 7, 12, 13, 14, 15, 17, 20, 21, 25, 27, 28, 37, 38, 39, 40, 41, 71; C. I. Reactive Red 3, 4, 7, 12, 13, 15, 16, 24, 29, 31, 32, 33, 43, 45, 46, 58, 59, 120, 180; C. I. Reactive Yellow 1, 2, 3, 13, 14, 15, 17; C. I. Reactive Orange 2, 5, 7, 16, 20, 24; C. I. Reactive Violet 2, 4, 5, 8; C. I. Reactive Brown 1, 7, 16; C. I. Reactive Green 5, 7, and the like. In addition, the dye may also be exemplified by C. I. Food Black 1 and 2.

As the pigment, various kinds of inorganic pigments and organic pigments other than carbon black may be used. The organic pigment may be exemplified by azo pigments such as azo lake pigment, insoluble azo pigment, condensed azo pigment, and chelate azo pigment; polycyclic pigments such as phthalocyanine pigment, perylene pigment, perynone pigment, anthraquinone pigment, quinacridone pigment, dioxazine pigment, thioindigo pigment, isoindolinone pigment, and quinophthalone pigment; dye lakes such as basic dye type lake, and acidic dye type lake; nitro pigments; nitroso pigments; and aniline black daylight fluorescent pigments, and the like. The inorganic pigment may be exemplified by titanium oxide-based pigment and iron oxide-based pigment. Other pigments are also usable provided that they are dispersible in the aqueous phase.

The method for dispersing the pigment in the water base ink may include a method using a dispersing agent such as surfactant and resin, and a method for introducing a surface functional group to the pigment to allow the pigment disperse by itself, but the method is not specifically limited.

As the dispersing agent for dispersing the pigment, it is possible to use high molecular weight dispersing agents used for dispersing pigment and surfactants. The high molecular weight dispersing agent may be specifically exemplified by proteins such as gelatin, albumin and casein; natural rubbers such as gum arabic and gum traganth; glucosides such as saponin; cellulose derivatives such as methyl cellulose, carboxy cellulose, and hydroxymethyl cellulose; natural high molecular weight compounds such as lignin sulfonic acid salt and shellac; anionic high molecular weight compounds such as polyacrylic acid salt, salt of styrene-acrylic acid copolymer, salt of vinylnaphthalene-acrylic acid copolymer, salt of styrene-maleic acid copolymer, salt of vinylnaphthalene-maleic acid copolymer, sodium salt of β-naphthalenesulfonic acid formalin condensate, and phosphoric acid salt; and nonionic high molecular weight compounds such as polyvinyl alcohol, polyvinyl pyrrolidone, and polyethylene glycol. The surfactant may be specifically exemplified by anionic surfactants such as fatty acid salts, higher alcohol sulfuric acid ester salts, liquid fatty oil sulfuric acid ester salts, and alkylarylsulfonic acid salts; and nonionic surfactants such as polyoxyethylene alkyl ethers, polyoxyethylene alkyl esters, sorbitan alkyl esters, and polyoxyethylene sorbitan alkyl esters. These surfactants may be used singly, or in a mixture of any combination thereof, as appropriate.

In general, the content of the dispersing agent in the water base ink is preferably 0.01 to 20% by weight, and more preferably 2 to 10% by weight with respect to the total amount of the ink.

The water base ink may contain a permeating agent so as to control the permeability of the water base ink. The permeating agent may be specifically exemplified by polyvalent alcohol alkyl ethers such as propylene glycol propyl ether, diethylene glycol monomethyl ether, diethylene glycol monobutyl ether, diethylene glycol monoisobutyl ether, diethylene glycol dimethyl ether, diethylene glycol diethyl ether, diethylene glycol dibutyl ether, dipropylene glycol monomethyl ether, dipropylene glycol monopropyl ether, dipropylene glycol monoisopropyl ether, dipropylene glycol monobutyl ether, dipropylene glycol dimethyl ether, dipropylene glycol dipropyl ether, dipropylene glycol dibutyl ether, triethylene glycol monomethyl ether, triethylene glycol monobutyl ether, tripropylene glycol monomethyl ether, tripropylene glycol monobutyl ether, triethylene glycol dimethyl ether, triethylene glycol dibutyl ether, tripropylene glycol dimethyl ether, and tripropylene glycol dibutyl ether.

The content of the permeating agent in the water base ink is preferably 0.05 to 15% by weight, and more preferably 0.5 to 8% by weight with respect to the total amount of the water base ink.

The water base ink may further contain monovalent alcohol such as ethanol and isopropyl alcohol for the purpose of controlling the permeability into the recording paper and the drying performance on the paper of the ink.

Further, the water base ink may contain a surfactant to adjust the surface tension of the ink for the purpose of satisfying, for example, the discharge stability, the introducing performance into the head, and the printing quality of the ink. The surfactant may be specifically exemplified by anionic surfactants such as higher fatty acid salt, alkyl sulfuric acid salt, alkyl ether sulfuric acid salt, alkyl ester sulfuric acid salt, alkylarylether sulfuric acid salt, alkyl sulfonic acid salt, sulfosuccinic acid salt, alkylarylsulfonic acid salt, alkylnaphthalenesulfonic acid salt, alkylphosphoric acid salt, polyoxyethylene alkylether phosphoric acid salt and alkylarylether phosphoric acid salt; cationic surfactants such as alkyl amine salt, dialkylamine salt, tetraalkylammonium salt, benzalkonium salt, alkylpyridinium salt, and imidazolinium salt; nonionic surfactants such as polyoxyethylene alkyl ether, polyoxyethylene alkylaryl ether, polyoxyethylene polyoxypropylene glycol, glycerol ester, sorbitan ester, sucrose ester, polyoxyethylene ether of glycerol ester, polyoxyethylene ether of sorbitan ester, polyoxyethylene ether of sorbitol ester, fatty acid alkanolamide, polyoxyethylene fatty acid amide, amine oxide, and polyoxyethylene alkylamine. However, the surfactant is not limited to these surfactants. These surfactants may be used singly, or in a mixture of any combination thereof. Further, the counter ion forming salt may be exemplified by sodium salt, triethanolamine salt, potassium salt, acid (hydrogen), chroline, and amine. However, the counter ion is not limited to these substances.

The water base ink may further contain a rustproofing agent so as to form a coating film on a metal surface such as an ink-jet head contacting with the water base ink, thereby preventing the corrosion of the metal surface. The rustproofing agent may be specifically exemplified by acidic sulfite, sodium thiosulfate, ammonium thiodiglycolate, diisopropyl ammonium nitrite, pentaerythritol tetranitrate, dicyclohexyl ammonium nitrite and benzotriazole. The content of the rustproofing agent in the water base ink is usually 0.01 to 5% by weight, preferably 0.05 to 3% by weight, and more preferably 0.1 to 1% by weight with respect to the total amount of the water base ink.

In the present invention, the water base ink may further contain, as necessary, a metal-sequestering agent, a moistening agent, a specific resistance-adjusting agent, a coating-forming agent, an ultraviolet radiation-absorbing agent, an antioxidizing agent, an antifading agent, a resin binder, and a antiseptic/fungicidal agent.

The ink tank, which is used for the ink cartridge for ink-jet recording apparatus of the present invention, can be manufactured by blending and uniformly mixing polyolefin with a sorbitol derivative as the crystal-nucleating agent and other additives in order to form pellets, and by molding the pellets with an ordinary method. Further, the ink cartridge for ink-jet recording apparatus of the present invention can be manufactured by filling the obtained ink tank with a water base ink for ink-jet recording in which a pH of the ink has been adjusted to be not less than 4.0 to less than 8.0.

The ink cartridge for ink-jet recording apparatus of the present invention, obtained in this manner, can be used in place of a conventional ink cartridge for ink-jet recording apparatus. Accordingly, in an ink-jet recording apparatus provided with the ink cartridge for ink-jet recording apparatus of the present invention, even when the cartridge includes the ink tank formed of polyolefin which contains the sorbitol derivative as the crystal-nucleating agent and has excellent transparency, the sorbitol derivative is prevented from depositing in the water base ink from the inner wall of the ink tank contacting with the ink.

### EXAMPLES

The present invention will be specifically explained by Examples. However, the present invention is not limited to the Examples. In addition, various changes, improvements and modifications may be made based on the knowledge of a person skilled in the art within a scope of the gist of the present invention.

### Examples for Preparing Inks

Dye-based inks for ink-jet recording (1) to (4) and (6) to (8) were respectively prepared as follows. The blending components indicated in Table 1 were weighed and sufficiently mixed and agitated. Then, the obtained mixture was filtrated through a membrane filter having a pore size of 0.2 μm. A pigment-based ink (5) was prepared with the same manner as the dye-based inks except that a membrane filter having a pore size of 1 μm was used for the filtration.

TABLE 1

| | Inks for ink-jet recording (% by weight) | | | | | | | |
|---|---|---|---|---|---|---|---|---|
| Blending components for ink | (1) | (2) | (3) | (4) | (5) | (6) | (7) | (8) |
| C.I. Direct Blue 199 (*1) | 3.0 | | | | | 3.0 | | |
| C.I. Direct Yellow 86 (*1) | | 1.0 | | | | | 1.0 | |
| C.I. Direct Yellow 132 (*1) | | 1.0 | | | | | 1.0 | |
| C.I. Reactive Red 120 (*1) | | | 2.5 | | | | | |
| C.I. Acid Red 52 (*1) | | | | | | | | 1.0 |
| C.I. Acid Red 289 (*1) | | | | | | | | 1.2 |
| C.I. Basic Red 1 | | | | 1.0 | | | | |
| C.I. Basic Yellow 2 | | | | 0.3 | | | | |
| CAB-O-JET 300 (*1, *2) | | | | | 4.0 | | | |
| glycerol | 30.0 | 30.0 | 20.0 | | 30.0 | 30.0 | 30.0 | 20.0 |
| diethylene glycol | | | 8.0 | | | | | 8.0 |
| polyethylene glycol (average | | | | 24.0 | | | | |
| molecular weight: 200) | | | | | | | | |
| 2-pyrrolidone | | | | 5.0 | | | | |
| triethylene glycol-n-butyl ether | 5.0 | | 1.5 | 6.0 | | 5.0 | | 1.5 |
| dipropylene glycol-n-propyl ether | | 3.0 | | | 1.5 | | 3.0 | |
| 1,2,3-benzotriazole | | 0.3 | 0.2 | | 0.1 | | 0.3 | 0.2 |
| Proxel XL2 (*3) | | | | | 0.2 | | | |
| triethanolamine | | | 0.1 | | | 0.1 | 0.2 | 0.1 |
| sodium salt of alkyl ether | | | 1.5 | | | | | 1.5 |
| sulfuric acid ester (*4) | | | | | | | | |
| water | balance | balance | balance | balance | balance | balance | balance | balance |

(*1): The amount of each of the coloring agents is a value corresponding to the solid amount of coloring agent.
(*2): Produced by Cabot.
(*3): Produced by Avecia K.K.
(*4): Number of carbons in alkyl group: 12 or 13

### Example for Preparing Ink Tank (A)

100 parts by weight of polypropylene (Y501N: polypropylene having an isotactic structure, produced by Sumitomo Mitsui Polyolefin Company, Limited) was blended with 0.2 part by weight of bis(p-methylbenzylidene) sorbitol as the crystal-nucleating agent, and then uniformly mixed. The mixture was subjected to die molding, and an ink tank (A) having a shape of rectangular parallelepiped, a volume of 20 ml and a wall thickness of 1.5 mm was obtained. The obtained ink tank (A) had excellent transparency.

### Example for Preparing Ink Tank (B)

An ink tank (B) having excellent transparency was obtained in the same manner as for the ink tank (A) except that bis(dimethylbenzylidene)sorbitol was used as the crystal-nucleating agent in place of bis(p-methylbenzylidene)sorbitol.

### Examples 1 to 5 and Comparative Examples 1 to 3

Ink cartridges for ink-jet recording apparatus of Examples 1 to 5 and Comparative Examples 1 to 3 were manufactured by filling 15 ml of the inks for ink-jet recording (1) to (8) to the ink tank (A) or (B), respectively. In the ink tanks of the obtained ink cartridges, the presence of ink contained in the ink tanks was observable from outside.

### Evaluation

When a water base ink is filled in an ink tank formed of polyolefin containing a sorbitol derivative as the crystal-nucleating agent and then the sorbitol derivative is eluted into the ink and deposited therein, and the ink after the deposition of the sorbitol derivative is filtrated through a metal mesh filter having a pore size of 10 μm, if the size of the deposited sorbitol derivative exceeds 10 μm, then the pore of the filter would be clogged by the deposited sorbitol derivative. Accordingly, with respect to each of the ink cartridges for ink-jet recording apparatus obtained in Examples and Comparative Examples, respectively, it is possible to evaluate, although indirectly, the presence or absence of deposited sorbitol derivative as the crystal-nucleating agent by performing the following Model Experiments for the materials used for the ink tanks, respectively.

Model Experiments

Polypropylene same as the materials for Ink Tank (A) and polypropylene same as the materials for Ink Tank (B) were respectively subjected to molding so as to obtain test pieces having a strip shape and size of 62 mm long, 12.7 mm wide and 3.2 mm thick. Test pieces were placed in glass jars by 10 pieces each, and 80 g of the inks for ink-jet recording (1) to (8) were poured in the glass jars, respectively. A pH meter (F-54 produced by Horiba, Ltd.) was used to measure the pH (pH before storage) of the respective inks. Afterwards, the inks were left to stand for two weeks in a thermostatic chamber in which the temperature was 60° C. Afterwards, the test pieces were removed, and then the inks were left to stand for one week at room temperature. Subsequently, the pH (pH after storage) of the respective inks was measured again. Also, Comparative Samples for comparing filtration speed were prepared by pouring, in glass jars, only the inks for ink-jet recording (1) to (8) without the test pieces placed therein, respectively, and the pH (pH before storage) of the respective inks were measured. Afterwards, the inks were left to stand for two weeks in a thermostatic chamber in which the temperature was 60° C., and then the inks were left to stand for one week at room temperature. Subsequently, the pH (pH after storage) of the respective inks was measured again. After the measurement of pH after storage, 20 g of each of the inks for ink-jet recording from the glass jars was filtrated through a metal mesh filter having a pore size of 10 μm at normal pressure, and the time required for 20 g of each of the inks to be completely filtered (filtration time) was measured. For each of the inks, the obtained filtration time were used to calculate filtration time ratio (=filtration time after immersion test/filtration time of comparative sample). Then, each of the inks was evaluated into four ranks based on the following criteria. The result of evaluations is indicated in Table 2. In this case, when the filtration time ratio for an ink is great, this means that the ink causes the clog-up of the filter more greatly. If such an ink is used in an ink-jet recording apparatus, there is a higher possibility that the ink causes clog-up of the nozzles and/or ink channels in the apparatus. Accordingly, from a practical point of view, it is desired that the filtration time ratio is less than 1.6 (namely, evaluation criteria A or B as described below).

Evaluation Criteria:

Rank Criteria
A: filtration time ratio is less than 1.3
B: filtration time ratio is not less than 1.3 to less than 1.6
C: filtration time ratio is not less than 1.6 to less than 3.5

D: filtration time ratio is not less than 3.5

TABLE 2

| | | | | | | Comparative | | |
|---|---|---|---|---|---|---|---|---|
| | Examples | | | | | Examples | | |
| | 1 | 2 | 3 | 4 | 5 | 1 | 2 | 3 |
| Ink for ink- | (1) | (2) | (3) | (4) | (5) | (6) | (7) | (8) |
| jet recording | | | | | | | | |
| Ink Tank | (A) | (A) | (B) | (A) | (B) | (A) | (A) | (B) |
| Content of | 0.2 | 0.2 | 0.2 | 0.2 | 0.15 | 0.2 | 0.2 | 0.2 |
| crystal- | | | | | | | | |
| nucleating | | | | | | | | |
| agent (part | | | | | | | | |
| by weight) (*5) | | | | | | | | |
| Value of pH | 7.1 | 7.6 | 7.9 | 4.5 | 7.5 | 8.2 | 8.3 | 8.5 |
| before storage | | | | | | | | |
| Value of pH | 6.8 | 7.5 | 6.2 | 4.1 | 7.1 | 8.1 | 8.2 | 8.4 |
| after storage | | | | | | | | |
| Evaluation of | A | B | A | A | A | D | D | C |
| filtering time | | | | | | | | |
| ratio | | | | | | | | |

(*5): Content with respect to 100 parts by weight of polypropylene (part by weight).

Each of the ink cartridges for ink-jet recording apparatus of Examples 1 to 5 has the ink tank which is formed of polypropylene containing the sorbitol derivative as the crystal-nucleating agent and which has the ink for ink-jet recording filled in the ink tank, the pH of the ink having been adjusted to be not less than 4.0 to less than 8.0. From the results indicated in Table 2, it is appreciated that in the ink cartridges for ink-jet recording apparatus of Examples 1 to 5, the evaluation of filtering time ratio were less than 1.6, respectively.

Accordingly, it is appreciated that the ink cartridges of Examples 1 to 5 are sufficient for realizing the control of discharge and landing of ink droplets with high accuracy.

In particular, with Examples 1 and 3 to 5 in which the filtering time ratio were less than 1.3, respectively, it is expected that problems would not be caused even when the ink tanks were stored under a severe condition such as at high temperature of not less than 40° C. for a long period of time, and thus the control of discharge and landing of ink droplets would be realized with high accuracy. Although in each of the ink tanks, the pH of ink was lowered after the storage, the cause therefor is considered to be the oxidation of a component such as solvent during storage.

On the other hand, in each of Comparative Examples 1 to 3, the filtering time ratio was not less than 1.6. If the ink cartridges of Comparative Examples 1 to 3 were stored for a long period of time, it is expected that the adverse effect of the clog-up of filter and nozzle would manifest itself, which in turn would deteriorate the discharge stability, and it would not be possible to realize the control of discharge and landing of the ink droplets with high accuracy. In particular, Comparative Examples 1 and 2, in which the filtering time ratio were not less than 3.5, respectively, are expected to be severely affected by the clog-up. Therefore, it is highly probable that with the ink cartridges of Comparative Examples 1 and 2, the discharge itself would be difficult with the nozzles being completely clogged and so on.

In the model experiments, a viscous substance which clogged the filter was collected and measured with a Fourier Transform Infrared Spectroscopy (FT-520(W) produced by Horiba, Ltd.). The measurement result was that a peak assigned to hydrogen bond at about 3,200 cm⁻¹, a peak assigned to benzen at 3,000 to 3,500 cm⁻¹, and a peak assigned to methyl group at 2,850 to 3,000 cm⁻¹, a peak assigned to ether group at 1,000 to 1,100 cm⁻¹, and the like were coincident with those of sorbitol derivative, respectively. Accordingly, it was appreciated that the substance which clogged the filter was a substance identical with or similar to a sorbitol derivative.

An embodiment of an ink-jet printer as the ink-jet recording apparatus provided with the ink cartridge manufactured in the above-described examples will be explained as follows with reference to the drawings.

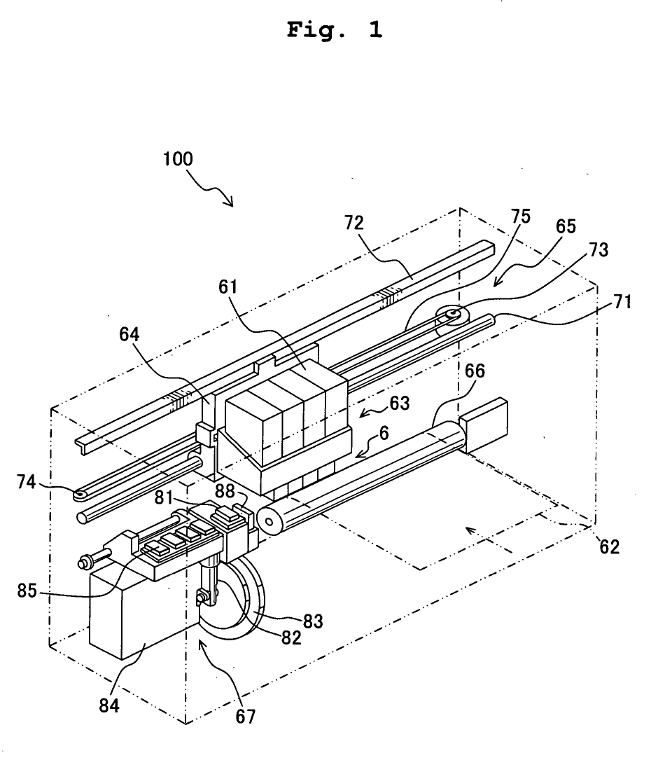

As shown in FIG. 1, a color ink jet printer 100 includes four ink cartridges (ink tank) 61, each of which contains a respective color of ink, such as cyan, magenta, yellow and black ink, a head unit 63 having an ink jet printer head 6 (hereinafter referred to as a head 6) for ejecting ink onto a sheet 62, a carriage 64 on which the ink cartridges 61 and the head unit 63 are mounted, a drive unit 65 which reciprocates the carriage 64 in a straight line, a platen roller 66 which extends in a reciprocating direction of the carriage 64 and is disposed opposite to the head 6, and a purge unit 67. As the black, cyan, magenta and yellow ink, the ink prepared in the above examples can be used.

The drive unit 65 includes a carriage shaft 71, a guide plate 72, two pulleys 73 and 74, and an endless belt 75. The carriage shaft 71 is disposed at a lower end portion of the carriage 64 and extends in parallel with the platen roller 66. The guide plate 72 is disposed at an upper end portion of the carriage 64 and extends in parallel with the carriage shaft 71. The pulleys 73 and 74 are disposed at both end portions of the carriage shaft 71 and between the carriage shaft 71 and the guide plate 72. The endless belt 75 is stretched between the pulleys 73 and 74.

As the pulley 73 is rotated in normal and reverse directions by a motor, the carriage 64, connected to the endless belt 75, is reciprocated in the straight direction, along the carriage shaft 71 and the guide plate 72, in accordance with the normal and reverse rotation of the pulley 73.

The sheet 62 is supplied from a sheet cassette (not shown) provided in the ink jet printer 100 and fed between the head 6 and the platen roller 66 to perform predetermined printing by ink droplets ejected from the head 6. Then, the sheet 62 is discharged to the outside. A sheet feeding mechanism and a sheet discharging mechanism are omitted from FIG. 1.

The purge unit 67 is provided on a side of the platen roller 66. The purge unit 67 is disposed to be opposed to the head 6 when the head unit 63 is located in a reset position. The purge unit 67 includes a purge cap 81, a pump 82, a cam 83, and a waste ink reservoir 84. The purge cap 81 contacts a nozzle surface to cover a plurality of nozzles (described later) formed in the head 6. When the head unit 63 is placed in the reset position, the nozzles in the head 6 are covered with the purge cap 81 to inhale ink including air bubbles trapped in the head 6 by the pump 82 and by the cam 83, thereby purging the head 6. The inhaled ink is stored in the waste ink reservoir 84.

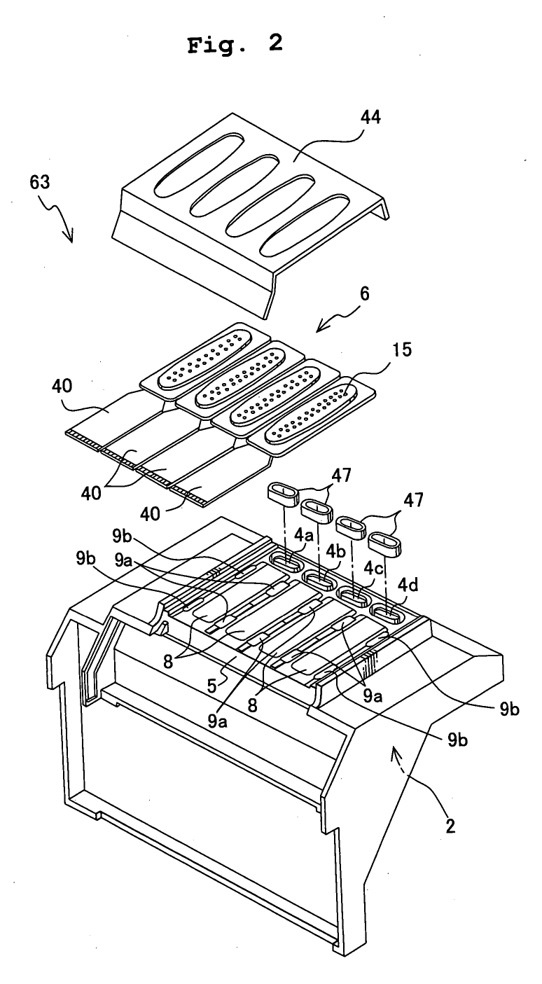

To prevent ink from drying, a cap 85 is provided to cover the nozzles 15 (FIG. 2) in the head 6 mounted on the carriage 64 when it returns to the reset position after printing. The ink jet printer 100 is further provided with a wiper 88 adjacent to the purge cap 81. The wiper 88 wipes the nozzle surface to remove the ink on the nozzle surface.

As shown in FIG. 2, the head unit 63 is mounted on the carriage 64 which moves along the sheet 62 and has a substantially box shape with upper open structure. The head unit 63 has a cover plate 44 made of an elastic thin metallic plate. The cover plate 44 is fixed at the front surface of the head unit 63 and covers the head unit 63 when the head 6 is removed. The head unit 63 also has a mounting portion 2 on which the four ink cartridges 61 are detachably attached from above. Ink supply paths 4a, 4b, 4c, 4d, each of which connects respective ink discharge portions of each ink cartridge 61, communicate with a bottom of a bottom plate 5 of the head unit 63. Each of the ink supply paths 4a, 4b, 4c, 4d is provided with a rubber packing 47 to intimately contact an ink supply hole 19a.

The head 6 is constructed from four blocks which are arranged in parallel to each other. On the underside of the bottom plate 5, four stepped supports 8 are formed to receive the respective blocks of the head 6. In the bottom plate 5, a plurality of recesses 9a, 9b, which are filled with an UV adhesive to bond the respective blocks of the head 6, are formed to penetrate the bottom plate 5.

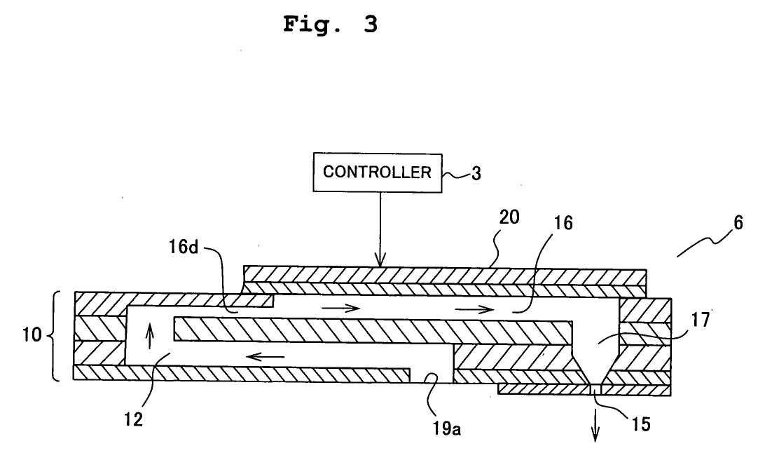

FIG. 3 is a sectional view showing one of the pressure chambers in the head 6. A plurality of pressure chambers 16 are provided in the head 6. The nozzles 15 communicating the respective pressure chambers 16 are provided substantially in line in one surface of the head 6.

As shown in FIG. 3, the head 6 is constructed by the cavity plate 10 comprised of a plurality of thin metal plates which are formed of nickel, iron, nickel alloy or iron alloy and the piezoelectric actuator 20. The cavity plate 10 has the ink supply holes 19a connected with the ink cartridge 61, the manifolds 12, the narrowed portions 16d, the pressure chambers 16, the through holes 17 and the nozzles 15, which communicate with each other. While the ink supply hole 19a opens toward the ejecting direction of the nozzle 15 in FIG. 3 for convenience, the ink supply hole 19a actually opens toward the piezoelectric actuator 20. A controller 3 provides a prestored driving pulse to the piezoelectric actuator 20 by superimposing the driving pulse on a clock signal.

Although the ink cartridge for ink-jet recording apparatus of the present invention uses the ink tank formed of the polyolefin which contains the sorbitol derivative as the crystal-nucleating agent and has excellent transparency, the sorbitol derivative as the crystal-nucleating agent is prevented from depositing-in the water base ink from the inner wall of the ink tank because the ink tank is filled with the water base ink which pH has been adjusted to be not less than 4.0 to less than 8.0. Accordingly, an ink-jet recording apparatus provided with the ink cartridge for ink-jet recording apparatus of the present invention is capable of preventing the clog-up of the nozzles and/or ink channel, realizing the highly accurate ink discharge and improving the printing quality.

What is claimed is:

1. An ink cartridge for ink-jet recording apparatus, comprising:
an ink tank formed of polyolefin including a crystal-nucleating agent; and
a water base ink filled in the ink tank and having a pH of not less than 4.0 to less than 8.0.

2. The ink cartridge according to claim 1, wherein the crystal-nucleating agent is a sorbitol derivative.

3. The ink cartridge according to claim 2, wherein the sorbitol derivative is one selected from the group consisting of dibenzylidene sorbitol, bis(p-methylbenzylidene)sorbitol, bis(p-ethylbenzylidene) sorbitol, bis(dimethylbenzylidene)sorbitol, bis(p-chlorobenzylidene)sorbitol, benzylidene-p-chlorobenzylidene sorbitol and benzylidene sorbitol in which benzylidene is substituted with an alkyl group having a number of carbon or carbons of 1 to 8.

4. The ink cartridge according to claim 1, wherein a content of the crystal-nucleating agent in the ink tank is 0.01 to 1 part by weight with respect to 100 parts by weight of the polyolefin.

5. The ink cartridge according to claim 1, wherein the polyolefin is polypropylene.

6. The ink cartridge according to claim 1, wherein the pH of the water base ink is not less than 6.0 to less than 7.5.

7. An ink jet-recording apparatus comprising the ink cartridge for ink-jet recording apparatus as defined in claim 1.

8. A method of manufacturing an ink cartridge for ink-jet recording apparatus, the method comprising:
providing an ink tank formed of polyolefin including a crystal-nucleating agent; and
charging a water base ink having a pH of not less than 4.0 to less than 8.0 in the ink tank.

9. The method according to claim 8, wherein the crystal-nucleating agent is a sorbitol derivative.

10. The method according to claim 9, wherein the sorbitol derivative is one selected from the group consisting of dibenzylidene sorbitol, bis(p-methylbenzylidene)sorbitol, bis(p-ethylbenzylidene) sorbitol, bis(dimethylbenzylidene)sorbitol, bis(p-chlorobenzylidene)sorbitol, benzylidene-p-chlorobenzylidene sorbitol and benzylidene sorbitol in which benzylidene is substituted with an alkyl group having a number of carbon or carbons of 1 to 8.

11. The method according to claim 8, wherein a content of the crystal-nucleating agent in the ink tank is 0.01 to 1 part by weight with respect to 100 parts by weight of the polyolefin.

12. The method according to claim 8, wherein the polyolefin is polypropylene.

13. The method according to claim 8, wherein the pH of the water base ink is not less than 6.0 to less than 7.5.
